(19) United States
(12) Patent Application Publication
(10) Pub. No.: US 2003/0228778 A1
(43) Pub. Date: Dec. 11, 2003

(54) MODEM ADAPTER USED IN VARIOUS COUNTRIES

(75) Inventor: Jessie Shang, Shanghai (CN)

Correspondence Address: BACON & THOMAS, PLLC, 625 SLATERS LANE, FOURTH FLOOR, ALEXANDRIA, VA, 22314

(73) Assignee: Shanghai Yurong Electronic Tech Co., Ltd., Shanghai (CN)

(21) Appl. No.: 10/162,918

(22) Filed: Jun. 6, 2002

(51) Int. Cl. H01R 29/00

(52) U.S. Cl. 439/172

(57) ABSTRACT

A modem adapter used in various countries comprises a female seat 1 with an RJ11 input port and a male seat 2 which can be inserted into telephone ports of various countries. The female seat can be connected to the male seat selected from one of a variety of countries. Thereby, the telephone port of different specifications used in different countries can be unified by the modem adapter used in various countries. The operation of the present invention is quick and efficient.

### BACKGROUND OF THE INVENTION

1. Field of the Invention

The present invention relates to a modem adapter, and particularly to an adapter used in the modem ports, which has a female seat with a RJ11 input end and a male seat of one of telephone ports of a variety of countries, such as UK, French, Italy, Belgium, Holland, Germany, Austria, Denmark, Finland, Norway, Sweden, Swiss, Czech, Australia, Poland, South Africa, Japan, Hungary, Brazil, Yugoslavia, etc.

2. Description of the Prior Art

The adapters of different countries are different. This is inconvenient in many fields, for example, in Europe. Currently, the network cards used are RJ11 port, and the net line is connected to two RJ11 line. For example, in UK, the telephone communication company uses UK PLUG (431PLUG) which is different from RJ11. Thereby, an internet connecting line used in French can not be used in UK since the telephone port is not matched. Thus, the user must buy an adapter or a RJ11 input port and a modem connectable to a 431A PLUG. Therefore, this induces inconvenience when one need travel through many nations.

### SUMMARY OF THE INVENTION

Accordingly, the primary object of the present invention is to provide a modem adapter used in various countries. The modem adapter used in various countries of the present invention comprises a female seat with an RJ11 input port and a male seat which can be inserted into telephone ports of various countries. The female seat can be connected to the male seat selected from one of a variety of countries. Thereby, the telephone port of different specifications used in different countries can be unified by the modem adapter used in various countries. The operation of the present invention is quick and efficient.

The various objects and advantages of the present invention will be more readily understood from the following detailed description when read in conjunction with the appended drawing.

### BRIEF DESCRIPTION OF THE DRAWINGS

FIG. 1 is an exploded perspective view of the first embodiment of the male seat of the present invention.

FIG. 2a is an exploded perspective view of the first embodiment of the male seat of the present invention.

FIG. 2b is an exploded perspective view of the first embodiment of the male seat of the present invention, wherein the opposite side of the male seat is illustrated.

FIG. 3 is an assembled perspective view of the first embodiment of the present invention.

FIG. 4 is an assembled perspective view of the first embodiment of the female seat of the present invention, which shows the opposite side of the seat.

FIG. 5 is a schematic view of the metal elastic wire of the female seat of the present invention.

FIG. 6a is a cross section view of the electronic wire of the female seat.

FIG. 6b is a front view of the electronic wire of the female seat of the present invention.

FIG. 7a is a perspective view of the terminal of the female seat according to the present invention.

FIG. 7b is an upper view of the terminal of the female seat according to the present invention.

FIG. 7c is a lateral view of the terminal of the female seat according to the present invention.

FIG. 8a is a perspective view about the male seat rotary ports of the female seat according to the present invention.

FIG. 8b is an upper view about the male seat rotary ports of the female seat according to the present invention.

FIG. 8c is a cross view about the male seat rotary ports of the female seat according to the present invention.

FIG. 8d is a bottom view about the male seat rotary ports of the female seat according to the present invention.

FIG. 9a is a perspective view of the connecting terminal base of the female seat according to the present invention.

FIG. 9b is a perspective view showing the opposite side of the connecting terminal base of the female seat according to the present invention.

FIG. 9c is a cross section view of the connecting terminal base of the female seat according to the present invention.

FIG. 9d is an upper view of FIG. 9a (i.e., a bottom view of FIG. 9b).

FIG. 9e is a bottom view of FIG. 9a (an upper view of FIG. 9b).

FIG. 10a is a perspective view of the fixing frame of the female seat according to the present invention.

FIG. 10b is a perspective view showing the opposite side of the fixing frame of the female seat according to the present invention.

FIG. 11a is a perspective view showing the female seat of the present invention with an RJ11 input port base.

FIG. 11b is a perspective view showing the opposite side of the female seat of the present invention with an RJ11 input port base.

FIG. 11c is an upper view of FIG. 11a.

FIG. 11d is a cross section view of FIG. 11a.

FIG. 11e is an upper view of FIG. 11b.

FIG. 12 is an assembled upper view showing the first embodiment of the female seat of the present invention which is installed with an fixing frame.

FIG. 13 is an assembled perspective view showing the first embodiment of the female seat of the present invention which is installed with a connecting terminal.

FIG. 14a is an exploded perspective view of the male seat of the present invention (showing the connection of the electronic wire from the rivet to the male seat conducting pins).

FIG. 14b is an exploded perspective view showing the opposite side of the male seat.

FIG. 15a is an assembled perspective view of the male seat of the present invention.

FIG. 15b is an assembled perspective view showing the opposite side of the male seat of the present invention.

FIGS. 16a to 16s are schematic perspective views showing the assembled male seats of various countries which have been assembled.

FIG. 17a is a perspective view of the male seat rotary port of the present invention.

FIG. 17b is a perspective view showing the opposite side of the male seat rotary port of the male seat of the present invention.

FIG. 17c is an upper view of FIG. 17a.

FIG. 17d is a cross section view along A-A of FIG. 17b.

FIG. 17e is a cross section view along A-A of FIG. 17c.

FIG. 17f is a cross section view along A-A of FIG. 17d.

FIG. 18a is a front view showing the rivets of the male seat of the present invention.

FIG. 18b is an upper view showing the rivets of the male seat of the present invention.

FIG. 18c is a bottom view showing the rivets of the male seat of the present invention.

FIG. 19a is a front view of the rivet connecting terminal of the male seat according to the present invention.

FIG. 19b is a lateral view of the rivet connecting terminal of the male seat according to the present invention.

FIG. 20 is an assembled view of the connecting terminals and electronic wires of the male seat according to the present invention.

FIGS. 21a to 21s are schematic views of the male seat conducting pines of pins of various countries.

FIG. 22a is a perspective view of the base stopper of the male seat according to the present invention.

FIG. 22b is a perspective view showing the opposite side of the base stopper of the male seat according to the present invention.

FIG. 22c is an upper view of FIG. 22a.

FIG. 22d is a cross section view of FIG. 22a.

FIG. 22e is an upper view of FIG. 22b.

FIGS. 23a to 23s are schematic views showing the base of the male seat in various countries.

FIG. 24 is a schematic cross sectional view showing that the rivets of the male seat of the present invention is fixed to the connecting terminal.

FIGS. 25a to 25e are schematic view showing that the female seat in the first embodiment of the present invention is applied to the products of UK, French, Italy, Belgium, Holland, Germany, Austria, Denmark, Finland, Norway, Sweden, Swiss, Czech, Australia, Poland, South Africa, Japan, Hungary, Brazil, Yugoslavia, etc. (including the front and back views after assembly or detached).

FIG. 26 is an exploded perspective view showing the assembly of the second embodiment of the female seat of the present invention.

FIG. 27a is an exploded perspective view of the second embodiment of the female seat according to the present invention.

FIG. 27b is an exploded perspective view showing the opposite side of the second embodiment of the female seat according to the present invention.

FIG. 28a is an assembled perspective view of the second embodiment of the female seat according to the present invention.

FIG. 28a is an assembled perspective view of the second embodiment of the female seat according to the present invention.

FIG. 28b is an assembled perspective view showing the opposite surface of the second embodiment according to the present invention.

FIG. 29 is a schematic view includes the surge absorber of the second embodiment of the female seat according to the present invention.

FIG. 30a is a schematic view of the LED indicator in the second embodiment of the female seat according to the present invention.

FIG. 30a is a schematic view showing the LED indicator the second embodiment of the female seat according to the present invention.

FIG. 30b is an upper view of FIG. 30a.

FIG. 31 is a perspective view of the base in the second embodiment of the female seat according to the present invention.

FIG. 32 is a schematic perspective view of the another aspect of FIG. 31.

FIGS. 33a to 33s are schematic view showing that the female seat in the second embodiment of the present invention is applied to the products of UK, French, Italy, Belgium, Holland, Germany, Austria, Denmark, Finland, Norway, Sweden, Swiss, Czech, Australia, Poland, South Africa, Japan, Hungary, Brazil, Yugoslavia, etc. (including the front and back views after assembly or detached).

### DETAILED DESCRIPTION OF THE PREFERRED EMBODIMENTS

The present invention relates to a modem adapter, and particularly to adapter used in the modem ports, which has a female seat 1 with a RJ11 input end and a male seat 2 of the telephone ports of a variety of countries (such as UK, French, Italy, Belgium, Holland, Germany, Austria, Denmark, Finland, Norway, Sweden, Swiss, Czech, Australia, Poland, South Africa, Japan, Hungary, Brazil, Yugoslavia, etc.)

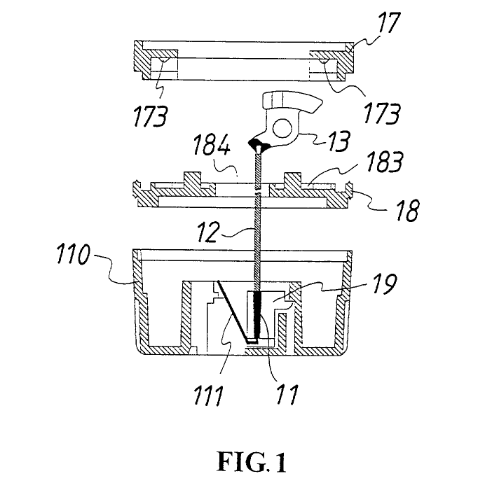

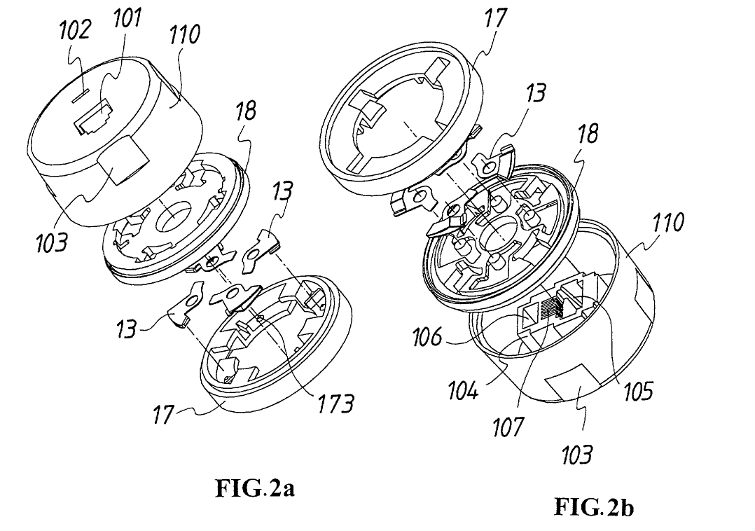

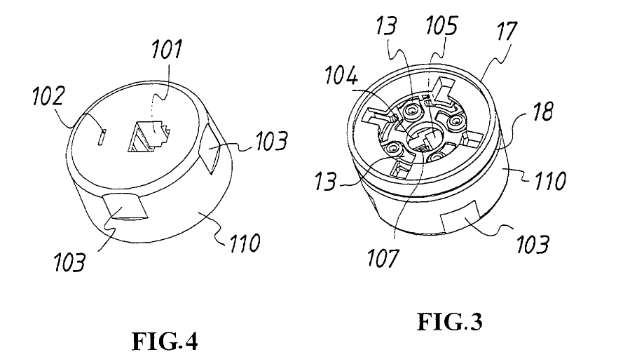

Above mentioned female seat 1 includes two embodiments. In the first embodiment, as shown in the FIGS. 1, 2a, 2b 3 and 4, the female seat 1 includes a metal elastic wire 11, an electronic wire 12, a plurality of connecting terminals 13, the female seat rotary port 17, a connecting terminal base 18, a fixing frame 19 and a base 10 with an RJ11 input.

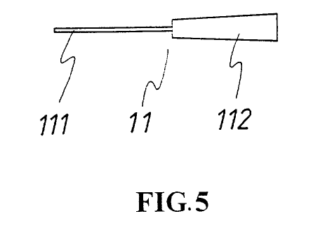

The metal elastic wire 11 is formed by a gold wire 111 and a terminal 112 riveting to the metal wire, as shown in the FIG. 5.

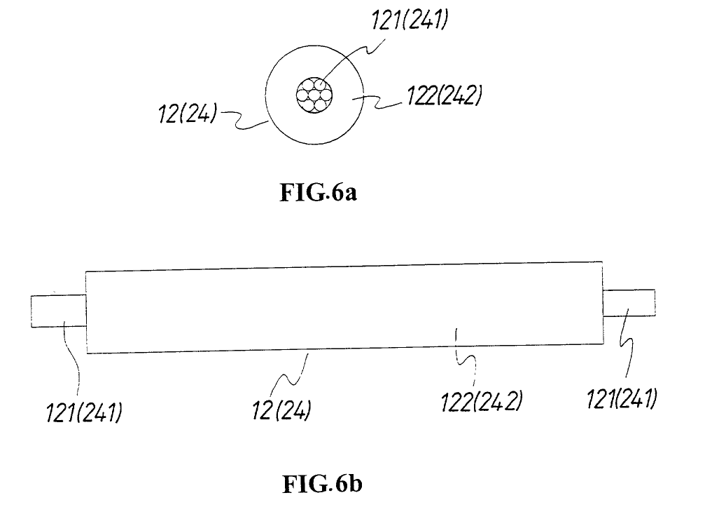

The electric wire 12 is formed by a conductive copper wire and a cover 122 enclosing the copper wire. The insulating cover 122 has different colors (referring to FIGS. 6a and 6b).

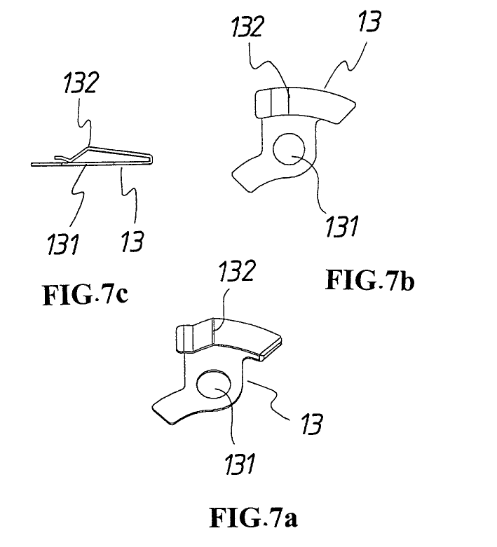

The plurality of terminals 13 is punched by bronze plate. The central hole 131 thereof is as a direction guide and copper plate is bent to be formed as a tip 132 so that the copper plate is elastic (referring to FIGS. 7a to 7c).

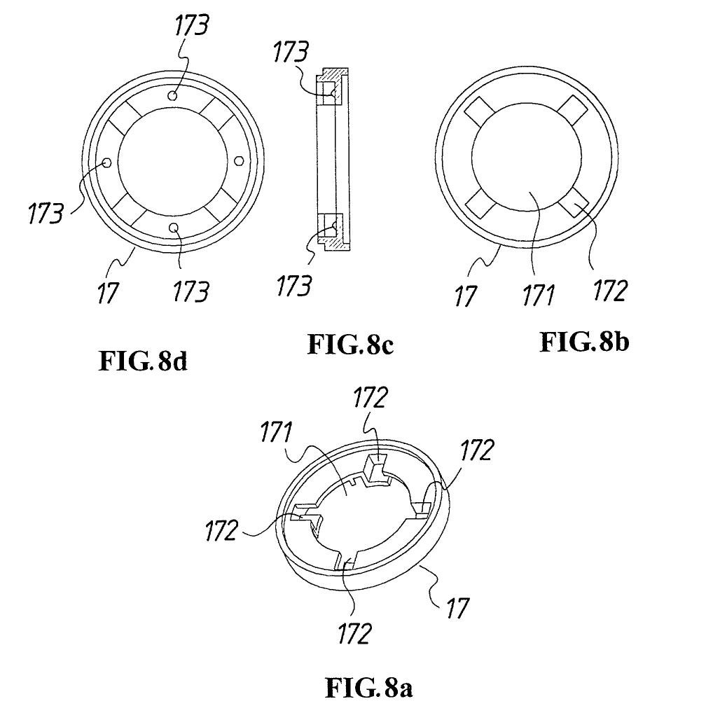

The male seat rotary port 17 is formed by a central circle 171 and four grooves 172. One side of each groove 172 is closed and the other side is opened. Four smaller tips 173 are formed (referring to FIGS. 8a to 8d).

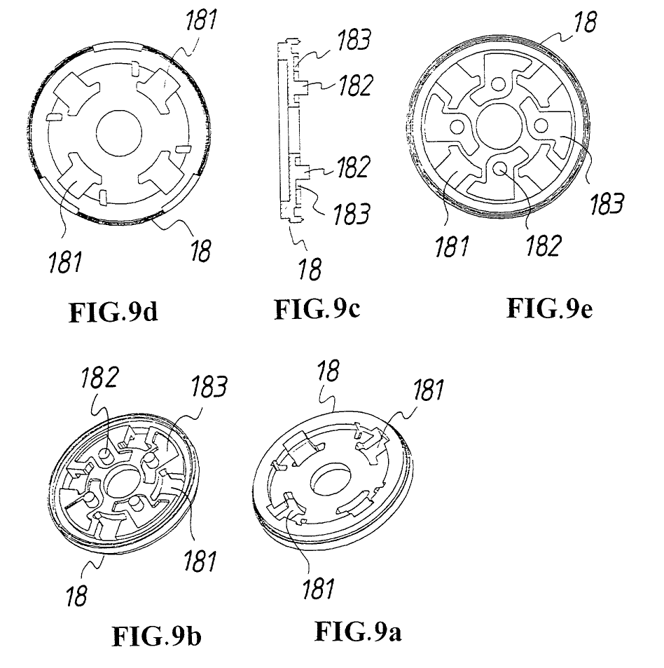

The connecting terminal seat 18 is formed by four regular holes 181 and four grooves each having a central guide post 182 (referring to FIGS. 9a to 9e).

The fixing frame 19 is an oblong body formed by six round holes 191 and a plurality of long grooves 192 at a head thereof.

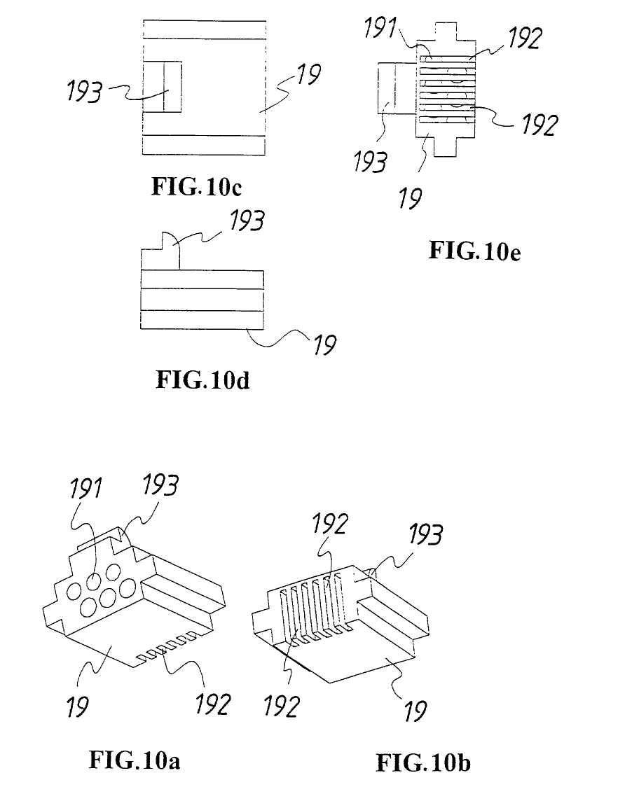

The bottom of each oblong body has a tip 193 (referring to FIGS. 10a to 10e).

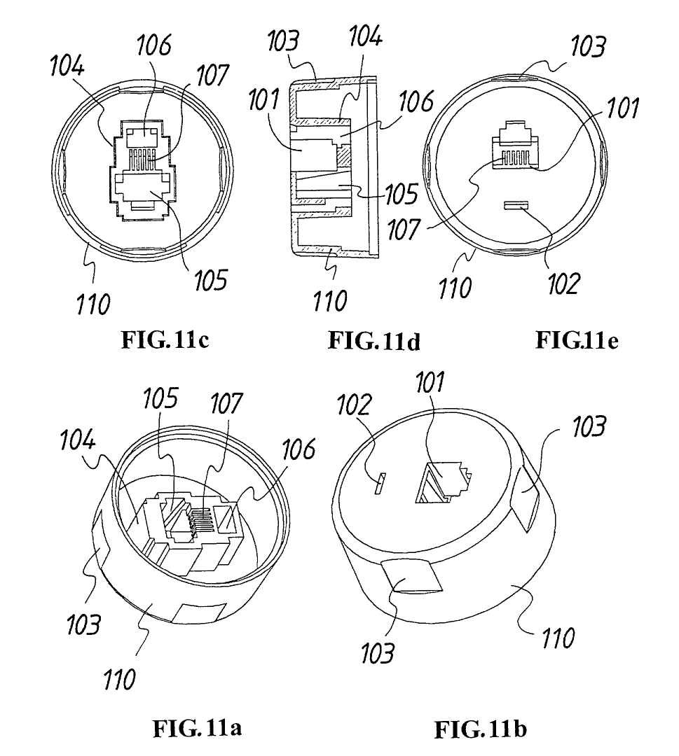

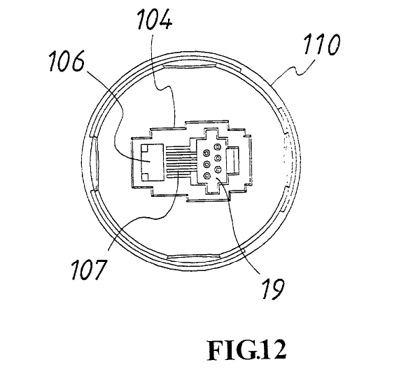

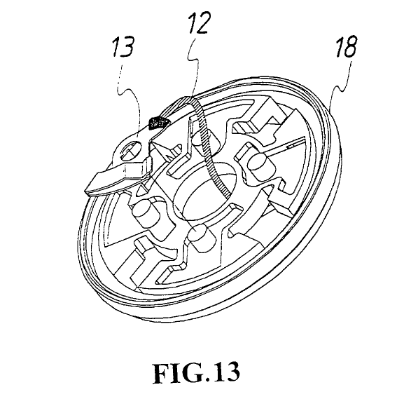

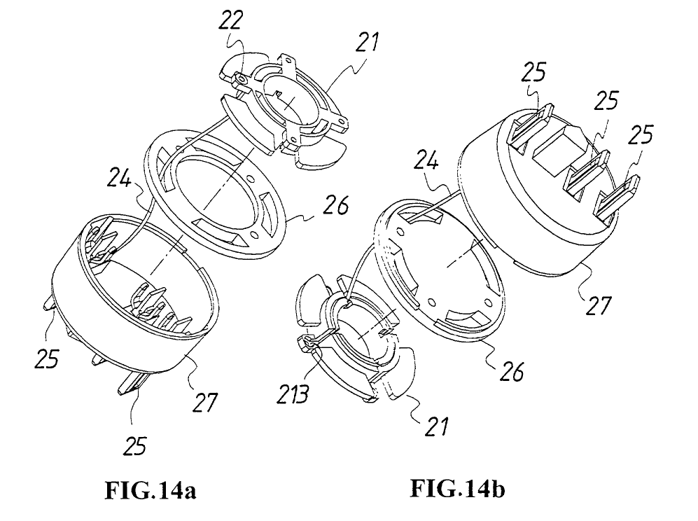

The seat 110 having a RJ11 input port has a “T” shape output port 101 (i.e., RJ11 input port) at a front portion thereof. The output port is communicated to a hole at a back side thereof. The outer side thereof has four regular grooves 103. A back side thereof has a non-regular protruding portion 104. The upper surface has two holes 105 and 106′. The hole 105 is connected to the six grooves 107 (referring to FIGS. 11a to 11e).

In assembling the female seat 1, the head end of the electronic wire 12 is striped with a length of 3 to 4 mm and then electronic wire 12 is riveted with the metal elastic wire 11 by riveting machine. The metal elastic wire 11 and electronic wire 12 are electrically conductive. Then, the metal elastic wire 11 is inserted into the fixing frame 19 (from the side having six holes). The metal elastic wire 11 must be fully inserted. Then the exposed metal wire 111 is bent through 45 degrees and then is inserted into the back side of the base 110 of the RJ11 input port. Then, another end of the electronic wire 12 is striped with a length of 3 to 4 mm. Then it passes through the central hole 184 of the connecting terminal base 18 and then the electronic wire 12 is connected to the distal end of the terminal 13. Then the terminal 13 is installed to the groove 183 of the connecting terminal base 18 (from the central hole of the copper piece). Then the copper terminal 13 is welded by supersonic wave to be fixed to the connecting terminal base 18. Finally, the RJ11 base 110, connecting terminal base 18 and the male seat rotary port 17 are connected by supersonic waves.

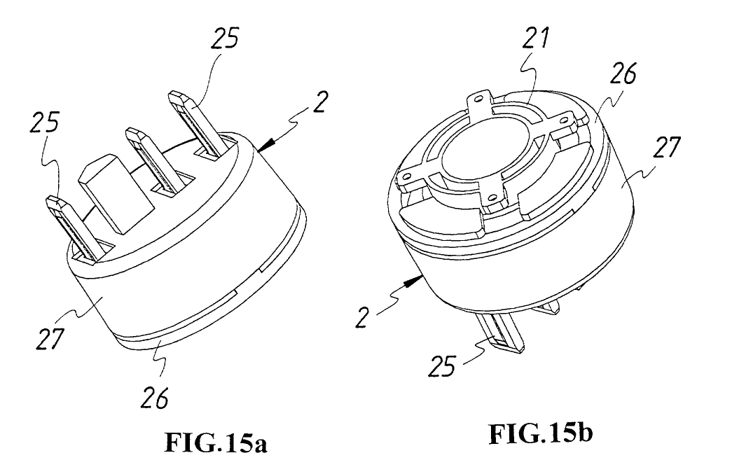

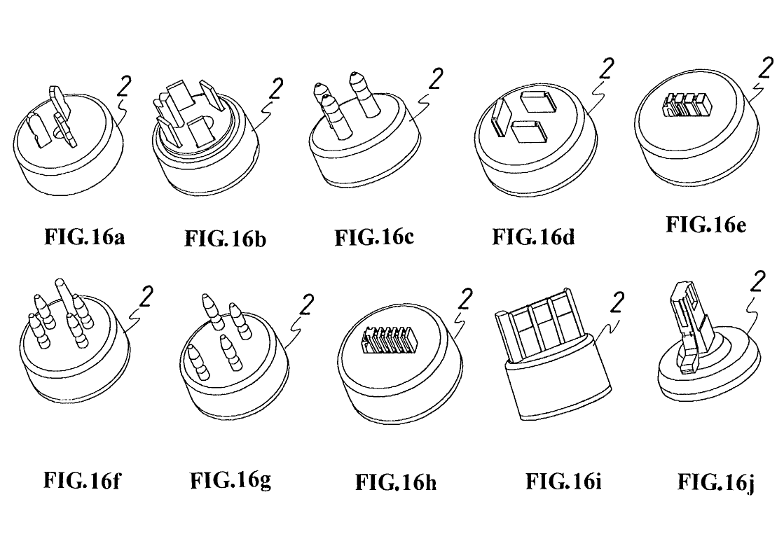

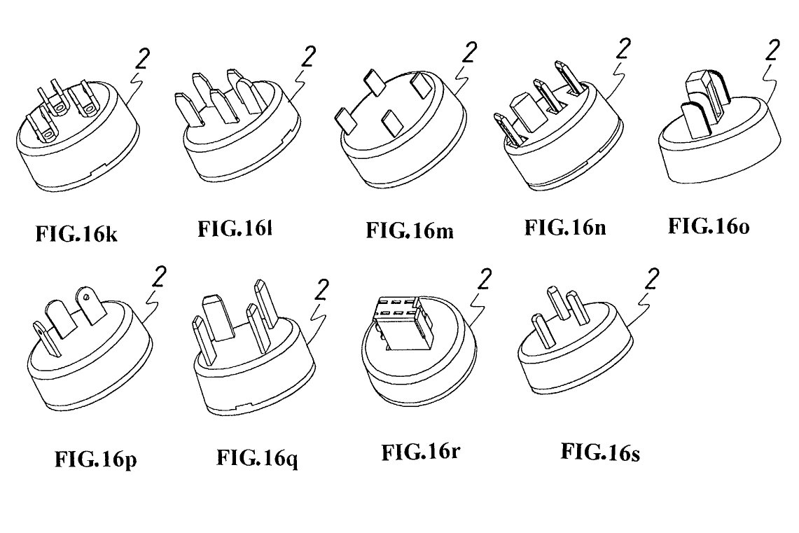

The embodiments about the female seat 1 of the present invention is illustrated in FIGS. 15a, 15b, FIGS. 16a to 16s. The female seat 1 includes male seat rotary port 21, rivets 22, rivet terminals 23, electronic wires 24, female seat connecting pins 25, base stopper 26 and base 27.

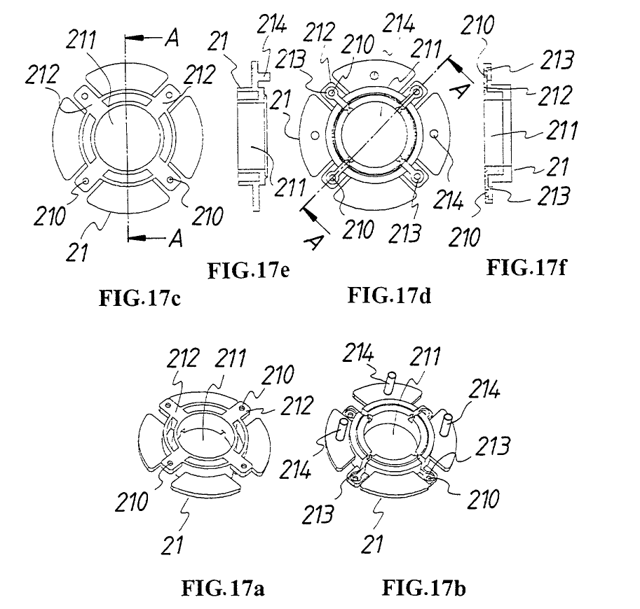

The male seat rotary port 21 is formed by a center circle 211 and four protruding pieces 212. The protruding pieces 212 have small round holes 210. A groove 213 extends from the small hole to the large hole. The back surface of the seat has three posts 214 (referring to FIGS. 17a to 17f).

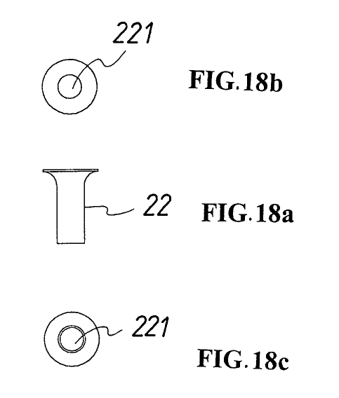

Each rivet 22 has a central hole 221 and the distal end has a trumpet opening (referring to FIGS. 18a to 18c).

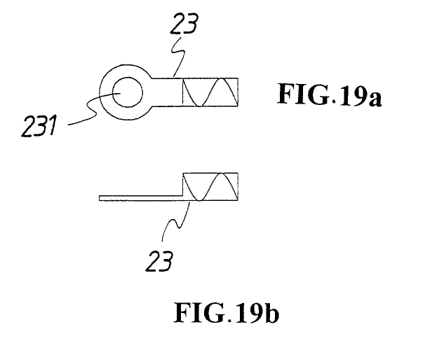

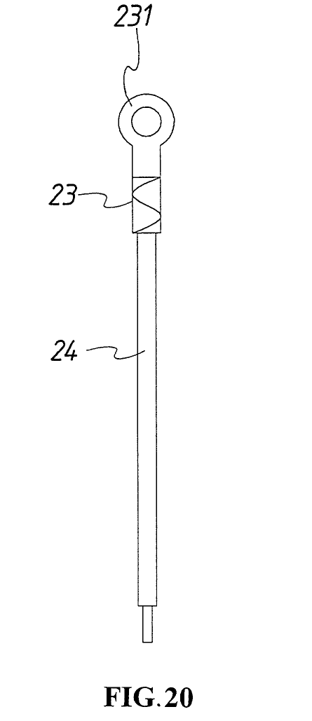

The rivet connecting terminal 23 is punched from bronze and the central hole 231 is used for directing. The whole is like a round circle and the distal end is used to rivet the electric wire body (referring to FIGS. 19a, 19b and 20).

The electronic wires 24 are formed by conductor copper wires 241 and insulating covers 242. The insulating covers 242 have various colors (referring to FIGS. 6a to 6b).

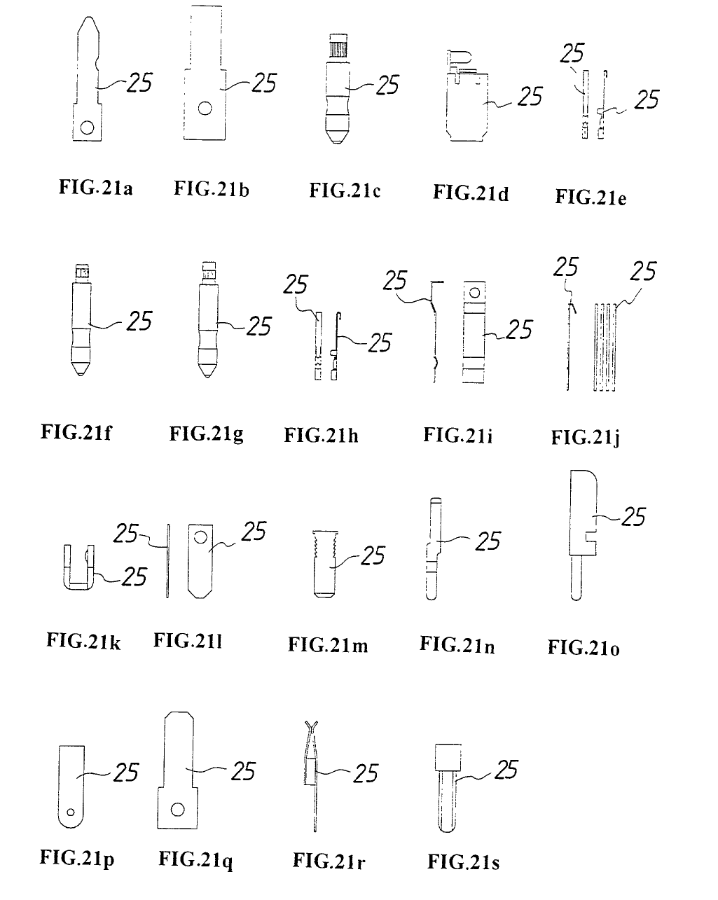

The male seat conducting pins 25 are formed by punching bronze copper plate and then plating nickel. The conductive pins are different from countries to countries (referring to FIGS. 21a to 21s).

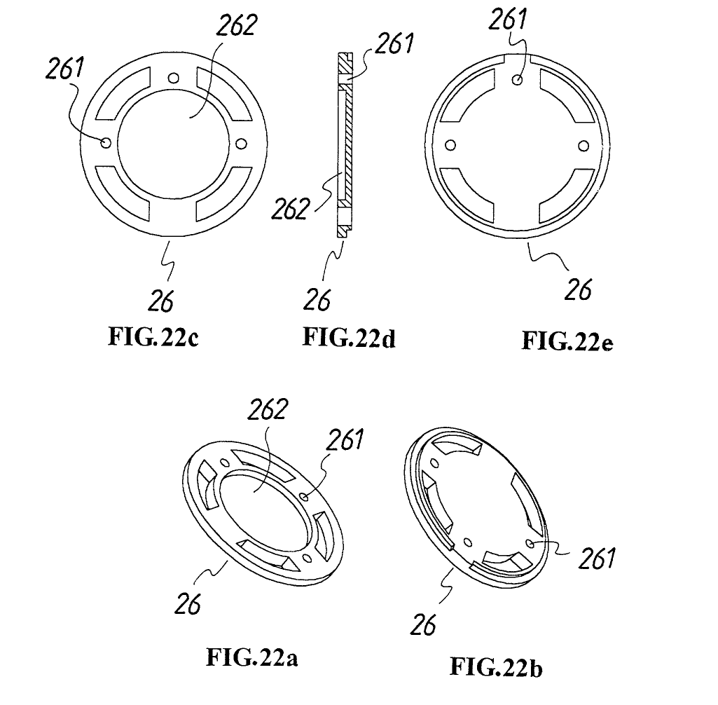

The base stopper 26 is a round plastic piece formed by three guide post 261 and a round groove 262 (referring to FIGS. 22a to 22e).

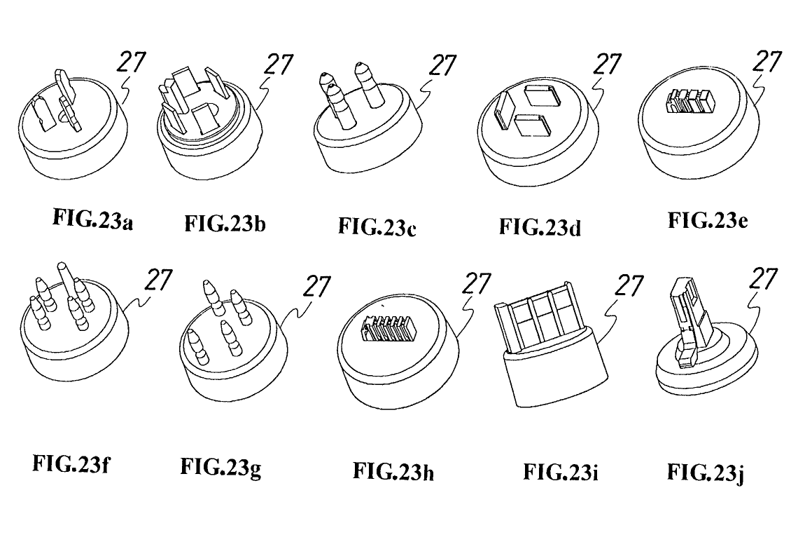

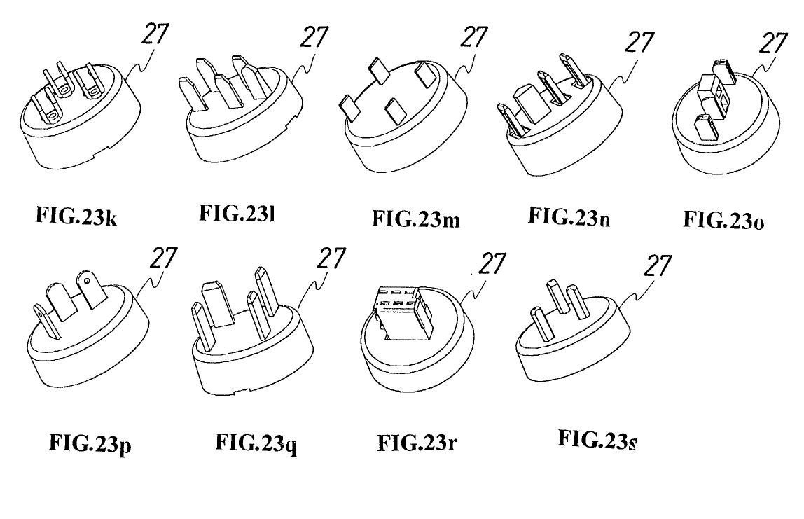

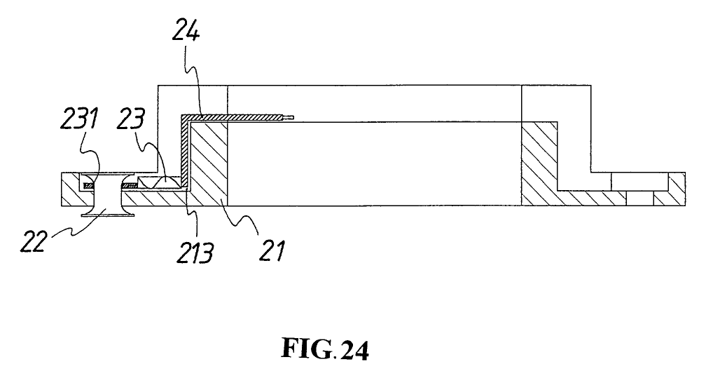

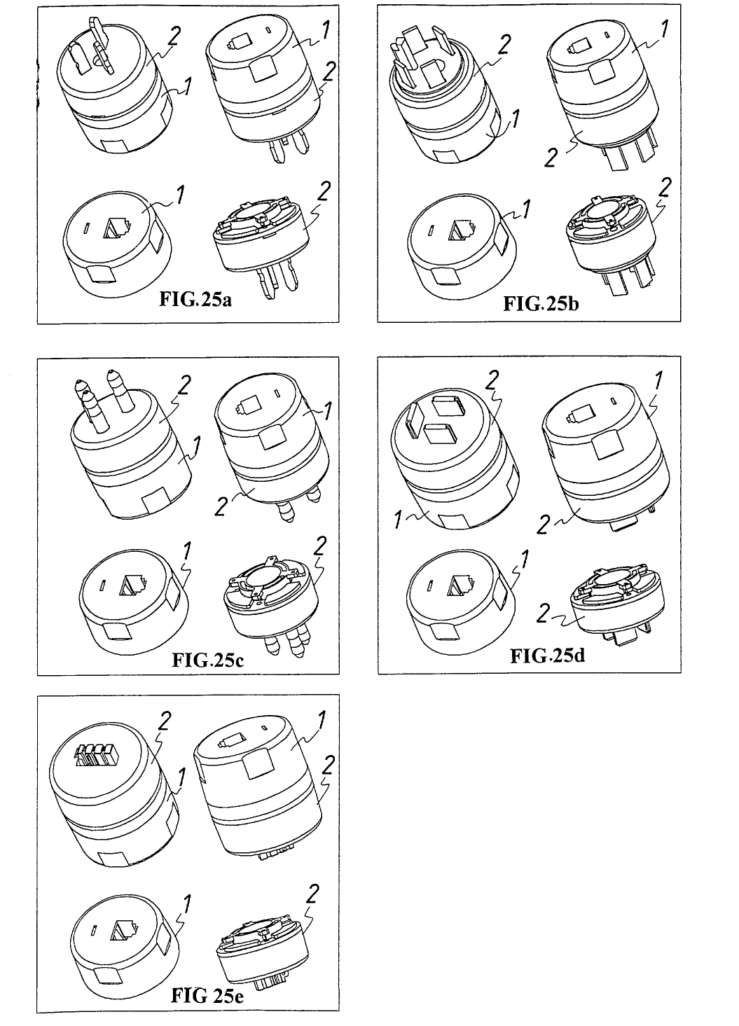

The base 27 is formed by various casing suiting for the cases of different countries (referring to FIGS. 23a to 23s).

In the assembly of male seat 2, the head end of the electronic wire 24 is striped with a length of 3 to 4 mm and then electronic wire 24 is riveted with the connecting terminal 23 by riveting machine. Then, the rivet 22 is inserted into the terminal 23 from the central hole 231. The terminals 23 are riveted with the four grooves 213 of the male seat rotary ports 21 by the rivets 22. Then, the electronic wires 24 are installed to the male seat rotary ports 21 along the directions of the grooves 213. Then another end of the electronic wire 24 passes through the base stopper 26 and then is connected to the base 27 of the male seat 2 which has been inserted b the male seat conductive pins 25. Finally, supersonic wave melting connection is used to connect the male seat rotary port 21, base stopper 26 and base 27.

The male seat 2 is used with the female seat 1 in the first embodiment. The supersonic wave connecting common female seat 1 is inserted by the male seat 2 of various countries. The insertion way will be described in the following.

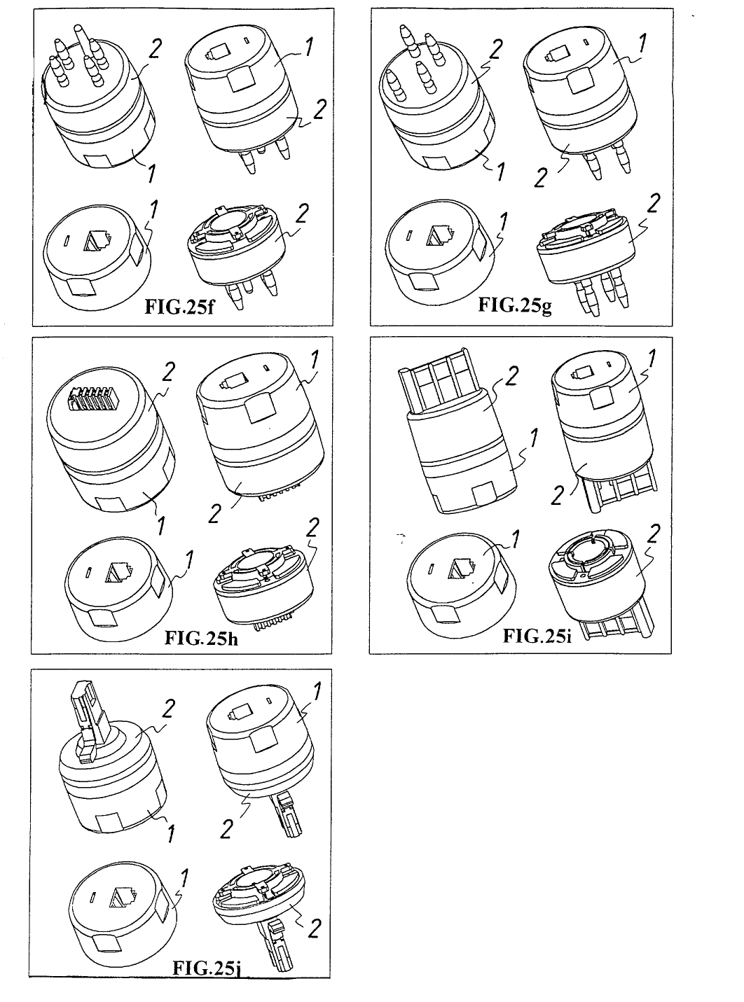

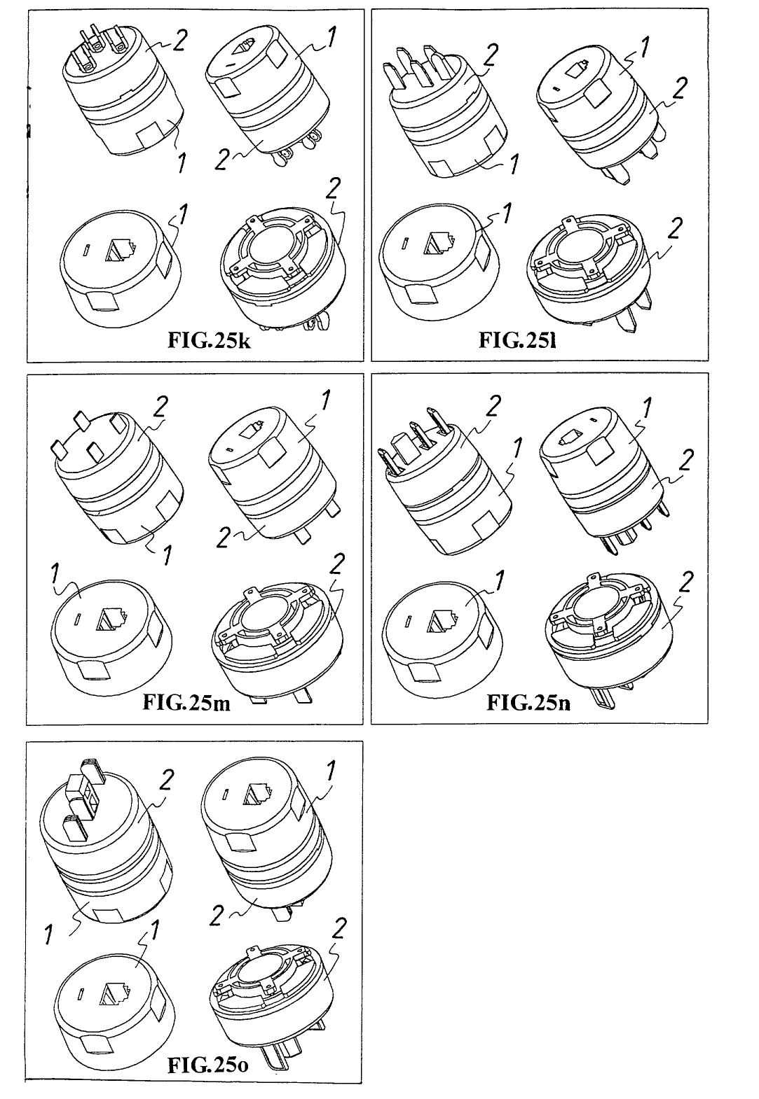

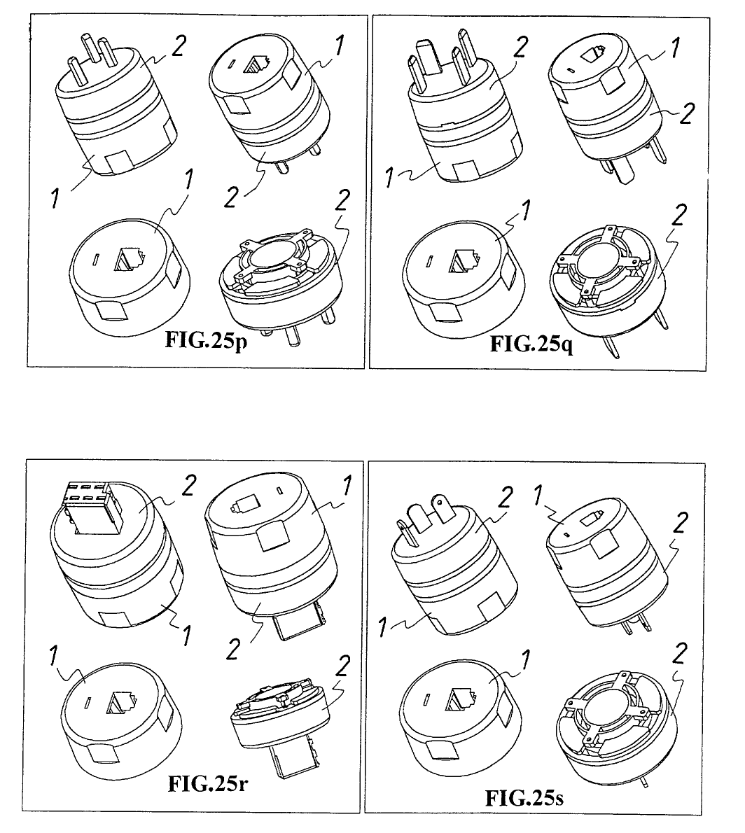

In use, the four films installed with rivets and terminals on the male seat rotary port 21 (protruding piece 212) is placed into the four grooves 213 of the male seat rotary port 21. Rotation with a predetermined direction, if a “ger ger” voice is emitted, it represents that the rivet 22 has in contact with the four tips 173 of the female seat rotary port 17. The rivets 22 at the bottom end will contact the male seat terminal 13. By the connection of the electronic wires 24 and 12 at two sides, the metal wire 111 in the RJ11 input port is connected with the conductive pins 25 of the male seat 2. Thus, the conversion between the rear RJ11 input port and the male seat 2 are complete. Likewise, in detaching, it is only necessary to screw out the male seat 2. This way is suitable for male seat of any country (referring to FIGS. 25a to 25s).

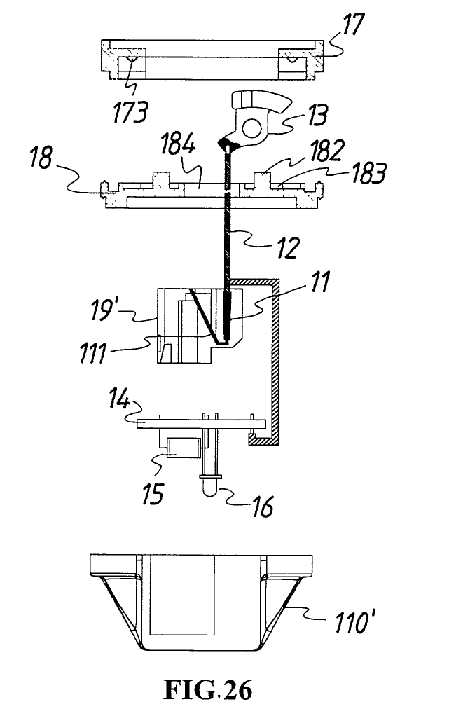

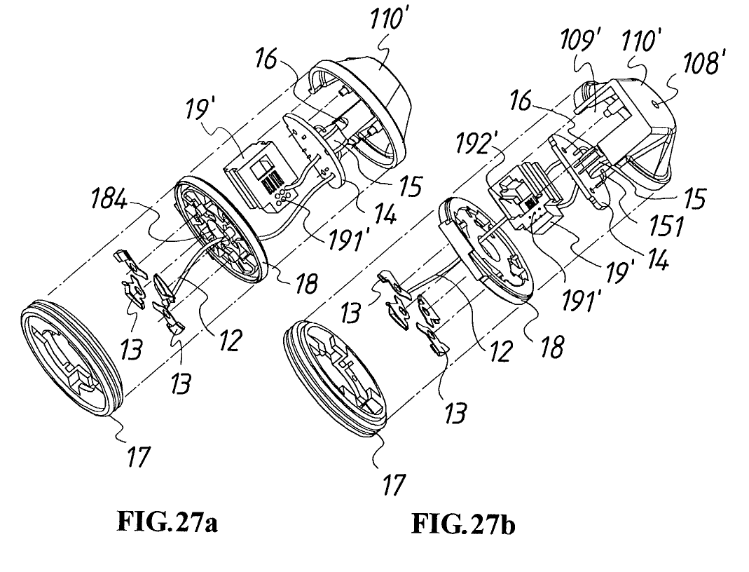

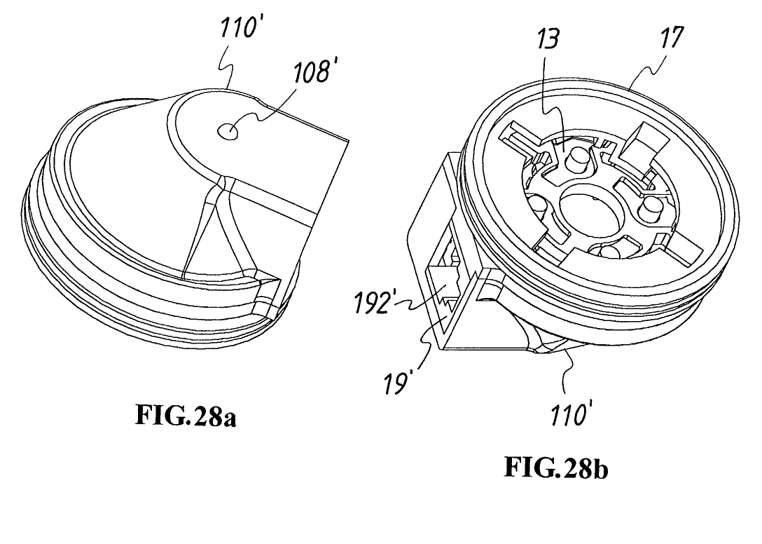

Based on above principle, the female seat 1 can be realized by two different embodiments, such as those disclosed in FIGS. 26a, 27a, 27b, 28a, and 28b. In the second embodiment, the female seat 1 is formed by a metal elastic wire 11, an electronic wire 12, a plurality of connecting terminals 13, a foil bakelite 14, a surge absorber 15, an LED indicator 16, a female seat rotary port 17, a connecting terminal base 18, a fixing frame 623K 19′, a base 110′, etc. The metal elastic wire 11, electronic wire 12, the plurality of connecting terminals 13, female seat rotary port 17, a connecting terminal base 18 are like those in the first embodiment, and thus the details will not be described herein.

The copper bakelite 14 has width of 1.6 mm. The copper bakelite has copper wires and small holes which can be inserted by electronic elements.

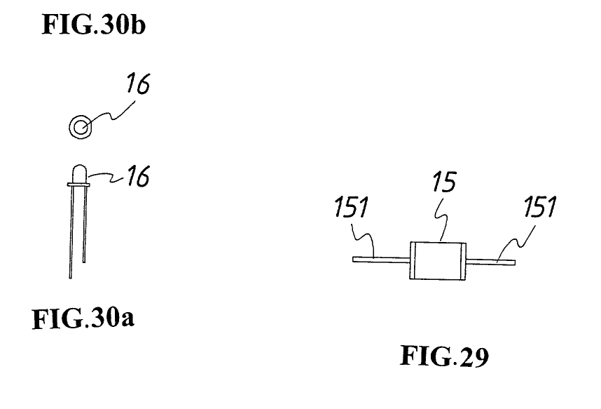

The surge absorber 15 is a cylinder with a diameter of 8.0 mm in the middle section and a length of 6.5 mm. Two sides thereof have electron elements with pins 151 (referring to FIG. 29).

The LED indicator 16 has a diameter of 3.0 mm at the head and a length of 5.5 mm. The LED indicator 16 is a transparent cylinder with a green or red color and has electron element with a long and a short leads (referring to FIGS. 30a and 30b).

The fixing frame 623K 19 is a plastic casing with six small rounds 191′ and a RJ11 input port 192′.

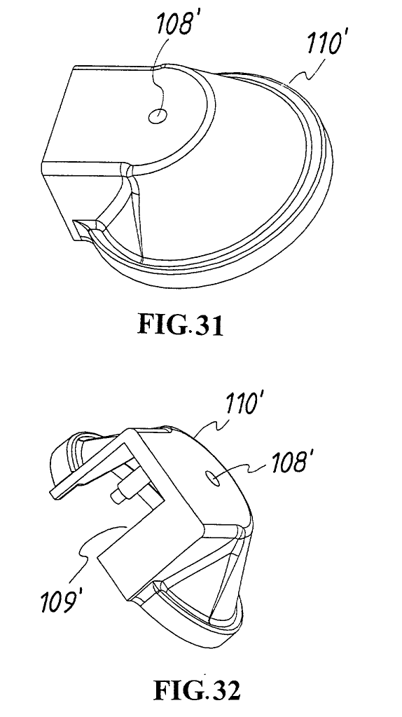

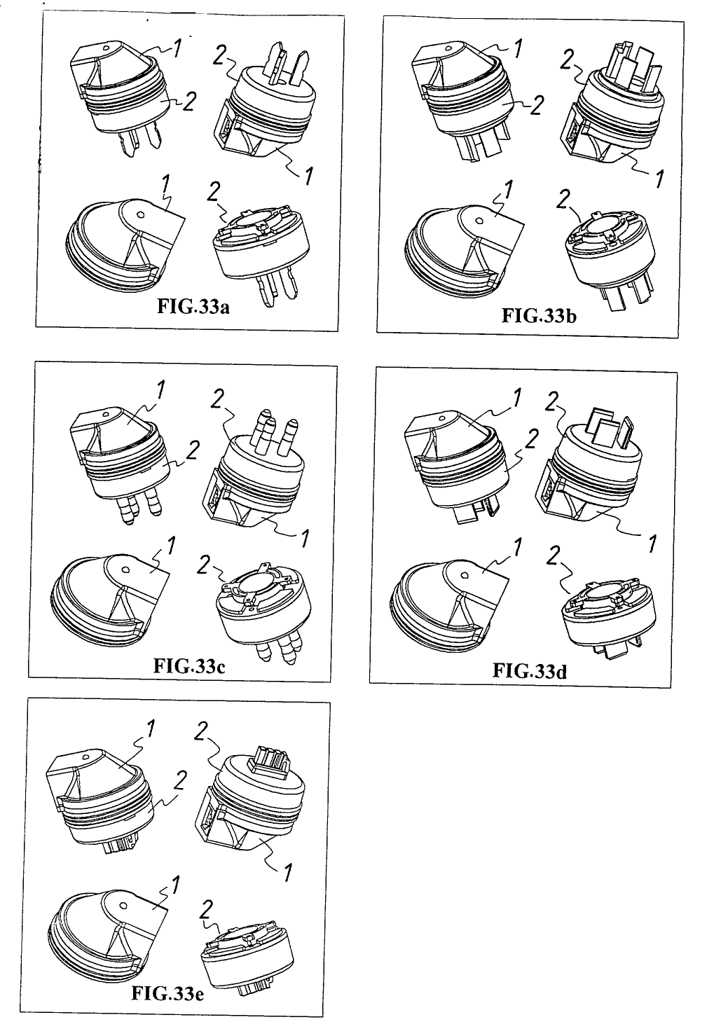

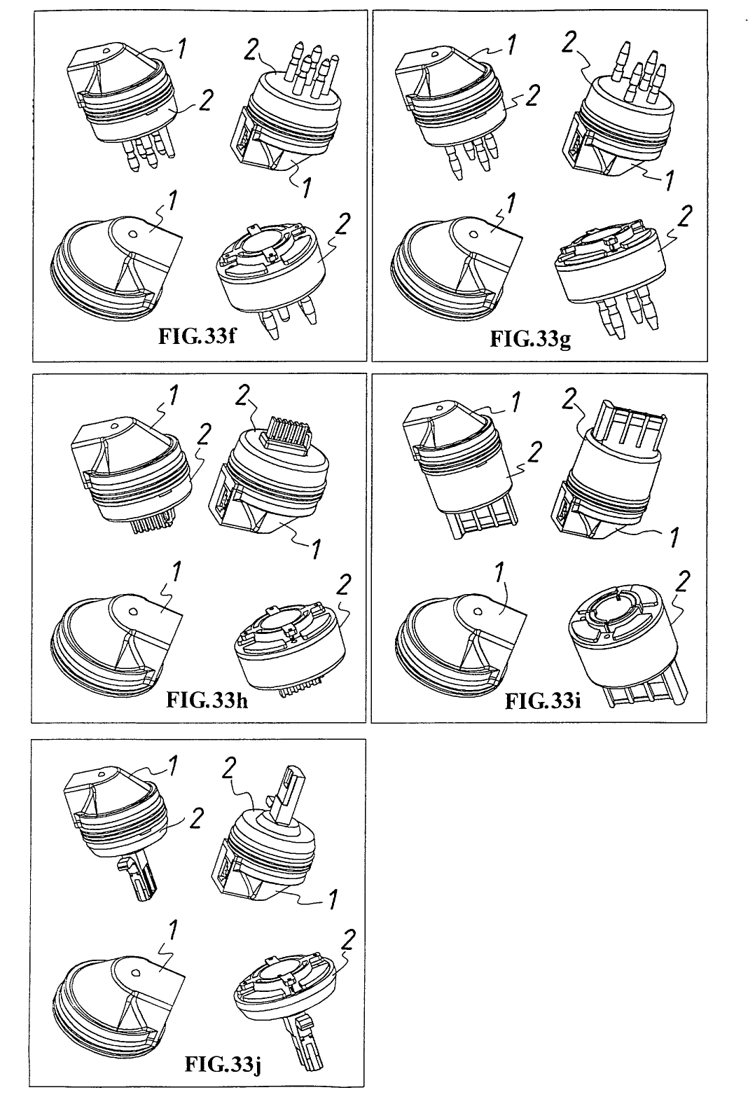

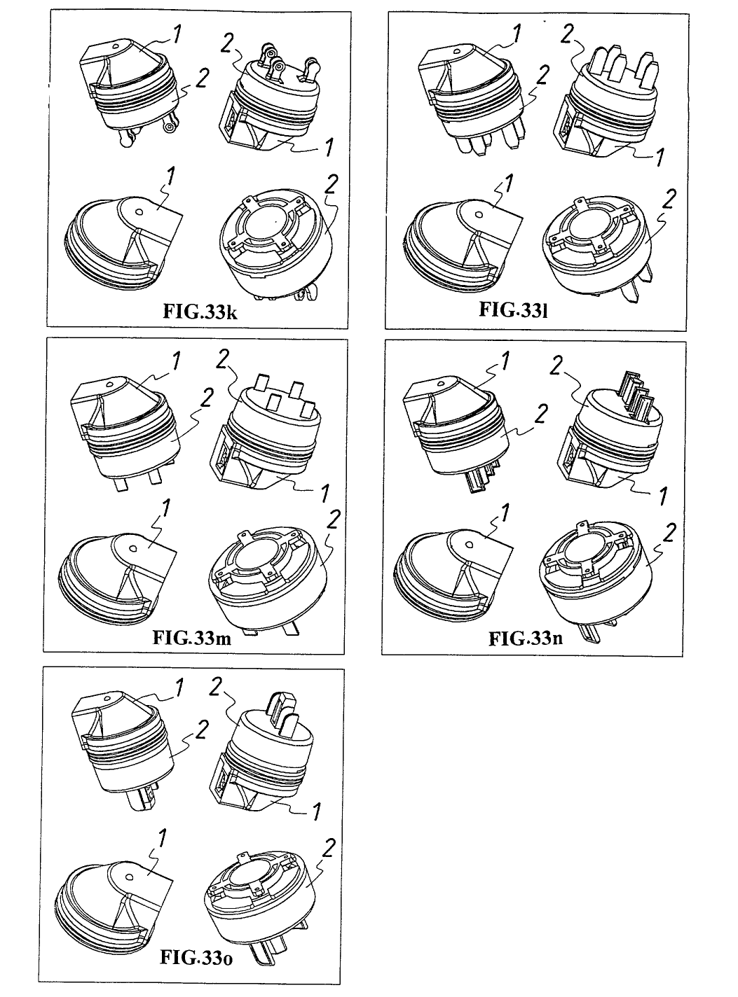

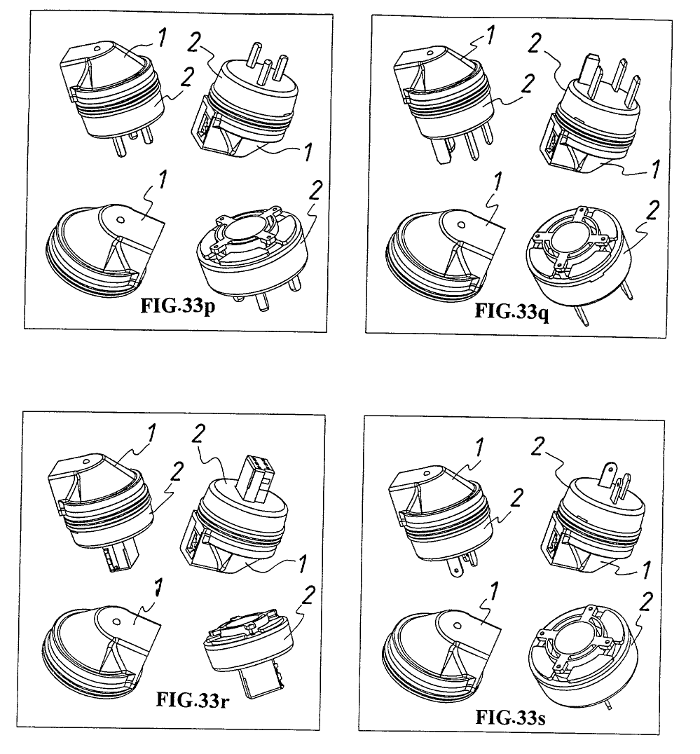

A front portion of the base 110′ has a round hole 108′ for receiving LED. A lateral side thereof has a rectangular hole 109′ for receiving RJ11 input port. The bottom thereof is hollowed (referring to FIGS. 31 and 32).

In assembling the female seat 1, the head end of the electronic wire 12 is striped with a length of 3 to 4 mm and then electronic wire 12 is riveted with the metal elastic wire 11 by riveting machine. The metal elastic wire 11 and electronic wire 12 are electrically conductive. Then, the metal elastic wire 11 is inserted into the fixing frame 623K 19′ (from the side having six holes). The metal elastic wire 11 must be fully inserted. Then the exposed metal wire 111 is bent through 45 degrees and then is inserted into the back side of the base 110 of the RJ11 input port. Then, another end of the electronic wire 12 is striped with a length of 3 to 4 mm and then is plated to the bakelite 14 at one end. Then it passes through the central hole 184 of the connecting terminal base 18 and then the electronic wire 12 is connected to the distal end of the terminal 13. Then the terminal 13 is installed to the groove 183 of the connecting terminal base 18 (from the central hole of the copper piece). Then the copper terminal 13 is welded by supersonic wave to be fixed to the connecting terminal base 18. Finally, the RJ11 base 110, connecting terminal base 18, copper bakelite 18, and the male seat rotary port 17 are connected by supersonic waves.

In the assembly of male seat 2 according to the second embodiment of the present invention, the four films installed with rivets and terminals on the male seat rotary port 21 (protruding piece 212) is placed into the four grooves 172 of the male seat rotary port 17 of the female seat 1 (having the LED indicator 16 and surge absorber 15). Rotation with a predetermined direction, if a “ger ger” voice is emitted, it represents that the rivet 22 has in contact with the four tips 173 of the female seat rotary port 17. The rivets 22 at the bottom end will contact the male seat terminal 13. By the connection of the electronic wires 24 and 12 at two sides, the metal wire 111 in the RJ11 input port is connected with the conductive pins 25 of the male seat 2. Thus, the conversion between the rear RJ11 input port and the male seat 2 are complete. When the female seat 1 is inserted into the male seat 2 of different countries, the modem wire is inserted into RJ11 input port and the LED diode will light up. Likewise, in detaching, it is only necessary to screw out the male seat 2. This way is suitable for male seat of any country (referring to FIGS. 25a to 25s).

1. A modem adapter used in various countries comprising a female seat 1 with an RJ11 input port and a male seat 2 which can be inserted into telephone ports of various countries, wherein:
the female seat 1 includes metal elastic wire 11, an electronic wire 12, a plurality of connecting terminals 13, a female seat rotary port 17, a connecting terminal base 18, a fixing frame 19 and a base 10 with an RJ11 input; two ends of the electronic wire 12 are connected to the metal elastic wire 11 and the connecting terminal 13, then the metal elastic wire 11 is inserted into the fixing frame 19; when the metal elastic wire 11 is reached to a bottom end of the fixing frame 19, a metal wire of the metal elastic wire 11 is bent and then is further inserted into the connecting terminal base 18; then the connecting terminal 13 at another end of the RJ11 input port is firmly secured to the connecting terminal base 18; then an RJ11 base 110, the connecting terminal base 18 and the female seat rotary port 17 are connected together;
the male seat 2 is inserted into one of a plurality of telephone ports of different countries; the male seat 2 includes a male seat rotary ports 21, rivets 22, a plurality of rivet connecting terminals 23, an electronic wires 24, a plurality of male seat conductive pins 25, an base stopper 26 and a base 27; the two ends of the electronic wire 24 are connected to the rivet connecting terminal 23 and the male seat conductive pins 25;
the rivets 22 serves to rivet each terminal 23 to the male seat rotary port 21 so that the electronic wire 24 passes through the base stopper 26 to be connected to the base 27 inserted by the male seat conductive pins 25; then the male seat rotary port 21, the base stopper 26 and the base 27 are connected together.

2. The modem adapter used in various countries as claim in claim 1, wherein the metal elastic wire 11 of the female seat 1 is formed by a metal wire 111 with a terminal riveting with the terminal 112.

3. The modem adapter used in various countries as claim in claim 1, wherein the electric wire is formed by a conductive copper wire 121 and a cover 122 enclosing the copper wire; the insulating cover 122 has different colors.

4. The modem adapter used in various countries as claim in claim 1, wherein the plurality of terminals 13 is punched by bronze plate; a central hole 131 thereof is as a direction guide and copper plate is bent so that the copper plate is elastic.

5. The modem adapter used in various countries as claim in claim 1, wherein the male seat rotary port 17 is formed by a central circle 171 and four grooves 172; one side of each groove 172 is closed and the other side is opened; four smaller tips 173 are formed.

6. The modem adapter used in various countries as claim in claim 1, wherein the connecting terminal seat 18 is formed by four regular holes 181 and four grooves each having a central guide post 182.

7. The modem adapter used in various countries as claim in claim 1, wherein the fixing frame 19 is an oblong body formed by six round holes 191 and a plurality of long grooves 192 at a head thereof; a bottom of each oblong body has a tip 193.

8. The modem adapter used in various countries as claim in claim 1, wherein the seat 110 having a RJ11 input port has a “T” shape output port 101 at a front portion thereof; an output port is communicated to a hole at a back side thereof; an outer side of the seat has four regular grooves 103; a back side of the seat has a non-regular protruding portion 104; the upper surface has two holes 105 and 106′; and the hole 105 is connected to the six grooves 107.

9. The modem adapter used in various countries as claim in claim 1, wherein the male seat rotary port 21 is formed by a center circle 211 and four protruding pieces 212; the protruding pieces 212 have small round holes 210; a groove 213 extends from the small hole to the large hole; a back surface of the seat has three posts 214.

10. The modem adapter used in various countries as claim in claim 1, wherein each rivet 22 of the male seat 2 has a central hole 221 and the distal end has a trumpet opening.

11. The modem adapter used in various countries as claim in claim 1, wherein the rivet connecting terminal 23 is punched from bronze and the central hole 231 is used for directing; the whole structure is like a round circle and a distal of the terminal end is used to rivet the electric wire body.

12. The modem adapter used in various countries as claim in claim 1, wherein the electronic wires 24 are formed by conductor copper wires 241 and insulating covers 242; the insulating covers 242 have various colors.

13. The modem adapter used in various countries as claim in claim 1, wherein the male seat conducting pins 25 are formed by punching bronze copper plate and then plating nickel; the conductive pins are different from countries to countries.

14. The modem adapter used in various countries as claim in claim 1, wherein the base stopper 26 is a round plastic piece formed by three guide post 261 and a round groove 262.

15. The modem adapter used in various countries as claim in claim 1, wherein the base 27 is formed by various casing suiting for the casings of different countries.

16. The modem adapter used in various countries as claim in claim 1, wherein the RJ11 base 110, connecting terminal base 18 and the male seat rotary port 17 of the male seat 2 are connected by supersonic waves.

17. The modem adapter used in various countries as claim in claim 1, wherein the male seat rotary ports 21, base stopper 26 and the base 27 of the male seat 2 are connected by supersonic waves.

18. The modem adapter used in various countries as claim in claim 1, wherein the male seat 2 is inserted to the male seat 2 selected from one male seat of various countries.

19. The modem adapter used in various countries as claim in claim 1, wherein the four films installed with rivets and terminals on the male seat rotary port 21 (protruding piece 212) is placed into the four grooves 213 of the male seat rotary port 21, then the male seat rotary ports is rotated with a predetermined direction, so that the rivet 22 has in contact with the four tips 173 of the female seat rotary port 17; and the rivets 22 at the bottom end will contact the male seat terminal 13; by the connection of the electronic wires 24 and 12 at two sides, the metal wire 111 in the RJ11 input port is connected to the conductive pins 25 of the male seat 2.

20. A modem adapter used in various countries comprising a female seat 1 with an RJ11 input port and a male seat 2 which can be inserted into telephone ports of various countries, wherein:
the female seat 1 is formed by a metal elastic wire 11, an electronic wire 12, a plurality of connecting terminals 13, a foil bakelite 14, a surge absorber 15, an LED indicator 16, a female seat rotary port 17, a connecting terminal base 18, a fixing frame 623K 19′, a base 110′; In assembling the female seat 1, the head end of the electronic wire 12 is striped with a length of 3 to 4 mm and then electronic wire 12 is riveted with the metal elastic wire 11 by riveting machine; the metal elastic wire 11 and electronic wire 12 are electrically conductive; and then, the metal elastic wire 11 is inserted into the fixing frame 623K 19′; the metal elastic wire 11 is fully inserted; then the exposed metal wire 111 is bent and then is inserted into the back side of the base 110 of the RJ11 input port; then, another end of the electronic wire 12 is is plated to the bakelite 14 at one end; then it passes through the central hole 184 of the connecting terminal base 18 and then the electronic wire 12 is connected to the distal end of the terminal 13; then the terminal 13 is installed to the groove 183 of the connecting terminal base 18; then the copper terminal 13 is welded by supersonic wave to be fixed to the connecting terminal base 18. Finally, the RJ11 base 110, connecting terminal base 18, copper bakelite 18, and the male seat rotary port 17 are connected; and
the male seat 2 is inserted into a telephone port of different country; the male seat 2 includes a male seat rotary ports 21, rivets 22, a plurality of rivet connecting terminals 23, an electronic wires 24, a plurality of male seat conductive pins 25, an base stopper 26 and a base 27.; the two ends of the electronic wire 24 are connected to the rivet connecting terminal 23 and the male seat conductive pins 25; the rivets 22 serves to rivet each terminal 23 to the male seat rotary port 21 so that the electronic wire 24 passes through the base stopper 26 to be connected to the base 27 inserted by the male seat conductive pins 25; then the male seat rotary port 21, the base stopper 26 and the base 27 are connected together.

21. The modem adapter used in various countries as claim in claim 20, wherein the metal elastic wire 11 of the female seat 1 is formed by a metal wire 111 with a terminal riveting with the terminal 112.

22. The modem adapter used in various countries as claim in claim 1, wherein the electric wire 12 is formed by a conductive copper wire 121 and a cover 122 enclosing the copper wire; the insulating cover 122 has different colors.

23. The modem adapter used in various countries as claim in claim 20, wherein the plurality of terminals 13 is punched by bronze plate; a central hole 131 thereof is as a direction guide and copper plate is bent so that the copper plate is elastic.

24. The modem adapter used in various countries as claim in claim 20, wherein the copper bakelite of the female seat 1 has copper wires and small holes which can be inserted by electronic elements.

25. The modem adapter used in various countries as claim in claim 20, wherein the surge absorber 15 is a cylinder; and two sides thereof have electron elements with pins 151.

26. The modem adapter used in various countries as claim in claim 20, wherein the LED indicator 16 is a transparent cylinder with a green or red color and has electron element with a long and a short leads.

27. The modem adapter used in various countries as claim in claim 20, wherein the male seat rotary port 17 is formed by a central circle 171 and four grooves 172; one side of each groove 172 is closed and the other side is opened; four smaller tips 173 are formed.

28. The modem adapter used in various countries as claim in claim 1, wherein the connecting terminal seat 18 is formed by four regular holes 181 and four grooves each having a central guide post 182.

29. The modem adapter used in various countries as claim in claim 20, wherein the fixing frame 623K 19 is a plastic casing with six small rounds 191′ and a RJ11 input port 192′.

30. The modem adapter used in various countries as claim in claim 20, wherein a front portion of the base 110′ has a round hole 108′ for receiving LED; a lateral side thereof has a rectangular hole 109′ for receiving RJ11 input port; a bottom thereof is hollowed.

31. The modem adapter used in various countries as claim in claim 20, wherein the male seat rotary port 21 is formed by a center circle 211 and four protruding pieces 212; the protruding pieces 212 have small round holes 210; a groove 213 extends from the small hole to the large hole; a back surface of the seat has three posts 214.

32. The modem adapter used in various countries as claim in claim 20, wherein each rivet 22 of the male seat 2 has a central hole 221 and the distal end has a trumpet opening.

33. The modem adapter used in various countries as claim in claim 20, wherein the rivet connecting terminal 23 is punched from bronze and the central hole 23 1 is used for directing; the whole structure is like a round circle and a distal of the terminal end is used to rivet the electric wire body.

34. The modem adapter used in various countries as claim in claim 20, wherein the electronic wires 24 are formed by conductor copper wires 241 and insulating covers 242; the insulating covers 242 have various colors.

35. The modem adapter used in various countries as claim in claim 20, wherein the male seat conducting pins 25 are formed by punching bronze copper plate and then plating nickel; the conductive pins are different from countries to countries.

36. The modem adapter used in various countries as claim in claim 20, wherein the base stopper 26 is a round plastic piece formed by three guide post 261 and a round groove 262.

37. The modem adapter used in various countries as claim in claim 1, wherein the base 27 is formed by various casing suiting for the casings of different countries.

38. The modem adapter used in various countries as claim in claim 20, wherein the RJ11 base 110, connecting terminal base 18, foil bakelite 14 and the male seat rotary port 17 of the male seat 2 are connected by supersonic waves.

39. The modem adapter used in various countries as claim in claim 20, wherein the male seat rotary ports 21, base stopper 26 and the base 27 of the male seat 2 are connected by supersonic waves.

40. The modem adapter used in various countries as claim in claim 20, wherein the male seat 2 is inserted to the male seat 2 selected from one male seat of various countries.

41. The modem adapter used in various countries as claim in claim 20, wherein the four films installed with rivets and terminals on the male seat rotary port 21 is placed into the four grooves 172 of the male seat rotary port 17 of the female seat 1 (having the LED indicator 16 and surge absorber 15); the male seat rotary ports 17 is rotated through a predetermined direction, the rivet 22 has in contact with the four tips 173 of the female seat rotary port 17; the rivets 22 at the bottom end will contact the male seat terminal 13; ty the connection of the electronic wires 24 and 12 at two sides, the metal wire 111 in the RJ11 input port is connected with the conductive pins 25 of the male seat 2.
